(19) United States
(12) Patent Application Publication
(10) Pub. No.: US 2026/0055025 A1
(43) Pub. Date: Feb. 26, 2026

(54) METHOD AND APPARATUS FOR INCINERATION OF COMBUSTIBLE WASTE DURING THE MANUFACTURE OF CEMENT CLINKER

(71) Applicant: FLSmidth Cement A/S, Valby (DK)

(72) Inventor: Steven Miller, Allentown, PA (US)

(21) Appl. No.: 19/105,497

(22) PCT Filed: Sep. 2, 2023
(86) PCT No.: PCT/IB2023/058694

§ 371 Date: Feb. 21, 2025

Related U.S. Application Data
(60) Provisional application No. 63/403,429, filed on Sep. 2, 2022.

(51) Int. Cl. C04B 7/44; C04B 7/43; C04B 7/47; F23G 5/44; F23J 1/06; F27D 17/18

(52) U.S. Cl. CPC C04B 7/4446; C04B 7/432; C04B 7/47; F23G 5/444; F23J 1/06; F27D 17/18; F23G 2205/10; F23G 2205/12; F23G 2205/20; F23G 2206/201; F23G 2209/30

(57) ABSTRACT

The present invention relates to a method for incineration of combustible waste during the manufacture of cement clinker where cement raw meal is preheated and calcined in a preheater (1) with a calciner (3), burned into clinker in a kiln (5) and cooled in a subsequent clinker cooler (7), in which method the waste is incinerated in a separate compartment (9) subject to simultaneous supply of hot air, the exhaust gases produced during the waste incineration process being vented to the preheater for heating the cement raw meal, and the slag generated during the waste incineration process being extracted from the compartment, the waste is introduced via a waste inlet (11) onto a supporting surface (21) incorporated in the compartment (9) and in that, during incineration, the waste is transported through the compartment to the outlet (23) of the compartment along a circular path, characterized in that the compartment (9) is arranged at a distance from said calciner (3) or a preheater tower by means of a material chute (40), said material chute (40) enters a downward sloping duct, said duct carries exit gas from said compartment (9) and non-combustible material from waste fuel firing in said compartment (9) down into the calciner or preheater tower.

### FIELD OF THE INVENTION

The present invention relates to a method for incineration of combustible waste during the manufacture of cement clinker where cement raw meal is preheated and calcined in a preheater, burned into clinker in a kiln and cooled in a subsequent clinker cooler. More particularly it relates to a method in which the waste is incinerated in a separate compartment subject to simultaneous supply of hot air, the exhaust gases produced during the waste incineration process being vented to the preheater for heating the cement raw meal, and the slag generated during the waste incineration process is extracted from the compartment.

The invention also relates to an apparatus for carrying out the method.

Non-limiting examples of combustible waste include tyres, furniture, carpets, wood refuse, garden waste, kitchen waste, paper sludge, sewage sludge, bleaching earth and old patent specifications.

The invention also relates to an HTM (Hot Material Transport) which is disconnecting the apparatus from the calciner/riser and moving it 2-8 meters away.

### BACKGROUND OF THE INVENTION

In DK patent application No. 1201/92, the contents of which are incorporated herein by reference, a method is disclosed in which the waste and cement raw meal are introduced at one end of the compartment and extracted at the other end, the transport takes place on specifically provided supporting surfaces and the waste slag and the cement raw meal are supplied into the calciner section of the preheater.

A disadvantage is the downtime needed to install the apparatus for incineration of waste during the manufacture of cement. A system and apparatus to reduce the downtime would be desirebale.

Another disadvantage is that the installation of the apparatus offer requires a reduction in the gas residence time in the calciner, especially for retrofits. It would be desirable to have a system and apparatus that did not reduce the calciner gas residence time.

### OBJECT OF THE INVENTION

An object of the present invention is to provide a method as well as an apparatus for incineration of waste during the manufacture of cement clinker by which the aforementioned disadvantages are remedied or significantly reduced.

### SUMMARY OF THE INVENTION

According to a first aspect of the present invention, a method of the kind mentioned in the introduction is provided, characterized in that the waste is introduced via a waste inlet onto a supporting surface incorporated in the compartment and in that, subject to simultaneous incineration, the waste is transported through the compartment to the outlet of the compartment along a circular path.

According to a second aspect of the present invention, there is provided an apparatus for incineration of combustible waste comprising a raw meal store, a preheater with a calciner, a kiln, a clinker cooler, a compartment for incineration of the waste, and an air duct for supplying hot air to the compartment, which compartment comprises an inlet for introducing the waste into the compartment and an outlet for extracting slag and any unburned waste, characterized in that the compartment further comprises a supporting surface for supporting the waste during incineration and means for transporting the waste from the waste inlet to the outlet of the compartment along a circular path.

Thus an apparatus is obtained which is distinguished by its simplicity from the viewpoint of design but also by the ability to dry wet waste, avoid fall-through of waste and possibly raw meal, while enhancing the potential to control the retention time of the waste in the compartment. Because of the circular motion, a more uniform distribution of the thermal load will occur, with heat being diverted from the hot end of the compartment to its cold end. Also, the retention time of the waste in the compartment may be controlled simply by varying the velocity of the transport means.

In order to optimize the capacity of the apparatus, it is preferred that for controlling the temperature in the waste incineration compartment, cement raw meal is introduced into the compartment via a cement raw meal inlet. The supplied raw meal will serve as a heat reservoir ensuring that the temperature is sustained at the target level even subject to fluctuations during incineration process between an exothermal process and an endothermal process, and conversely. Thus, the compartment may incorporate an inlet for introducing raw meal from the preheater, calciner and/or raw meal store.

To ensure limited energy consumption and a high oxygen content in the airstream, it is preferred that the hot airstream being fed to the compartment is extracted from the clinker cooler. In certain instances where, for example, the kiln comprises a bypass system for ventilation of volatile compounds, a small amount of the hot air fed to the compartment may also advantageously be extracted from the bypass system.

It is preferred that the exhaust gases produced during the waste incineration process are fed to the calciner of the preheater for calcination of the cement raw meal. As a consequence hereof, any undesirable combustion products, CO, soot etc. will be decomposed in the calciner subject to simultaneous incineration of the ordinary fuel in the calciner.

The slag generated during the waste incineration process and any unburned waste are preferably extracted from the compartment through its outlet and directed into the calciner.

In event of risk of overheating and/or explosion, it will not be possible to interrupt the incineration process in the compartment instantaneously as is possible in a traditional burner, and, for this reason, it is preferred that cold raw meal from a raw meal store or a dedicated emergency hopper may be supplied to the compartment under such circumstances. Also it is preferred that the cold raw meal is fed to the compartment in a quantity which is sufficient to cool the waste and to shield it against the impact of the hot airstream.

In a preferred embodiment of the invention, the compartment may be arranged at a distance from the calciner or a preheater tower by means of a material chute. The material chute preferably enters a downward sloping duct. The duct carries exit gas from the compartment and non-combustible material from waste fuel firing in the compartment down into the calciner or preheater tower.

This enables the apparatus to be disconnected from the calciner/riser and moving it 2-8 meters away. The advantage is the reduction of the downtime needed to install the apparatus for incineration of waste during the manufacture of cement.

The mechanical means for moving the non-combustible means are preferably arranged in the duct, so as to ensure that said material flows downwards.

The mechanical means may be the form of air blasters arranged in the duct or in the form of a mechanical pusher to move the non-combustible material down the chute.

The mechanical means may be in the form of a mechanical pusher located in the duct.

In a preferred embodiment of the invention the supporting surface comprises a rotary disc which simultaneously serves as a means for transporting the waste through the compartment.

In the preferred embodiment the apparatus also comprises a scraper mechanism for expelling the slag generated during the waste incineration process as well as any unburned waste from the compartment at its outlet and into the calciner.

The rotary disc may partially or wholly constitute the bottom of the compartment.

The rotary disc may be configured for rotation about a substantially vertical axis which extends through its center. The axis may be inclined relative to the vertical level, substantially between 1 and 10 degrees. So, if the rotary disc is made to slope slightly towards the outlet of the compartment, this will improve the rate of extraction of slag and waste residue from the compartment and the diversion into the calciner.

To avoid circulation of the air in the compartment, the latter preferably comprises a gas-tight, stationary partition wall which is mounted at the path of rotation between the outlet and inlet of the compartment, extending from the side wall of the compartment to the axis of rotation of the rotary disc.

The rotary disc preferably comprises a ceramic material.

### BRIEF DESCRIPTION OF THE FIGURES

The figures show one way of implementing the present invention and is not to be construed as being limiting to other possible embodiments falling within the scope of the attached claim set.

FIG. 1 shows a traditional Hot disc layout

FIG. 2 shows a detail of a preferred embodiment of the layout in FIG. 1

FIG. 3 shows a top view of the detail shown in FIG. 2

FIG. 4 shows a detail of an alternative embodiment of the layout in FIG. 1

FIG. 5 shows a top view of the detail shown in FIG. 4.

FIG. 6 shows an apparatus according to the present invention

### DETAILED DESCRIPTION OF THE INVENTION

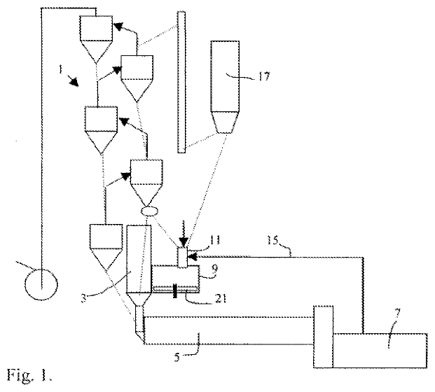

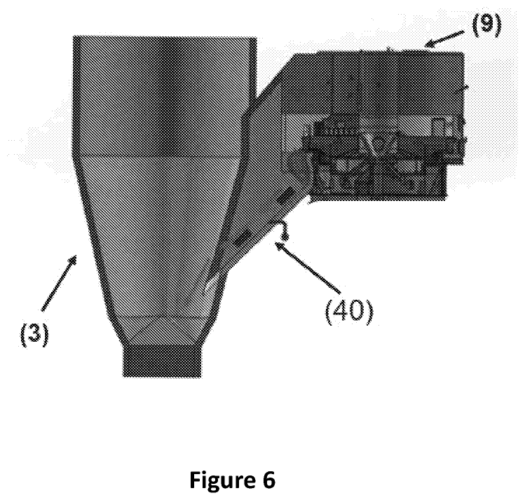

It shall be noted, that the following description of FIGS. 1-5 is related to a traditional setup of the Hot disc, and should be construed as being part of the prior art. FIG. 6 and the corresponding description constitutes the present invention.

FIG. 1 shows an apparatus for manufacturing cement clinker. The apparatus includes a cyclone preheater 1 with calciner 3, a rotary kiln 5, a clinker cooler 7 and a compartment 9 for incineration of waste which is introduced via an opening 11 in the compartment. During operation the cement raw meal is directed from a raw meal store 17 to the raw meal inlet F of the preheater 1. The raw meal is subsequently directed towards the rotary kiln 5 through the cyclones of the preheater 1 and the calciner 3 in counterflow to hot exhaust gases from the rotary kiln 5, thereby causing the raw meal to be heated and calcined. In the rotary kiln 5 the calcined raw meal is burned into cement clinker which is cooled in the subsequent clinker cooler 7 by means of atmospheric air. Some of the air thus heated is routed from the clinker cooler 7 via a duct 15 to the compartment 9.

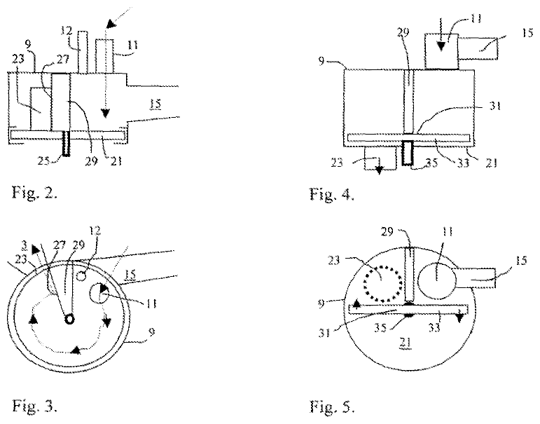

Waste is introduced via the waste inlet 11 on a supporting surface 21 (see FIG. 2) in the compartment 9, whereafter the waste is ignited and incinerated while, at the same time, the waste is transported to the outlet 23 of the compartment along a circular path.

-For controlling the temperature in compartment 9, the compartment is further seen to incorporate an inlet 12, see FIGS. 2 and 3, for introducing cement raw meal from the preheater, calciner and/or raw meal store.

In the embodiment shown in FIGS. 2 and 3, the supporting surface is made up of a rotary disc 21 which rotates about an axis 25 and which constitutes the bottom of the compartment 9. In order to direct the incineration residues in the form of slag and possibly unburned waste through the outlet 23 of the compartment and into the calciner 3, the compartment 9 comprises a scraper mechanism 27.

In this embodiment, waste is dumped via the inlet 11 onto the rotary disc 21. From here the waste is transported as shown by means of the arrows in a circular path to the outlet 23 of compartment 9 where the scraper mechanism 27 will ensure that all material on the rotary disc is pushed over the edge and into the calciner 3 where sorting takes place, causing small particles to drift upwards in the calciner while large particles flow downstream to the kiln or are disintegrated. Hence the mineral constituents of the waste are effectively blended into the raw meal components.

As illustrated, the compartment also comprises a gas-tight, stationary partition wall 29 which is mounted in the path of rotation between the outlet 23 of the compartment and inlet 11. The partition wall, which is an integral part of the scraper embodiment 27 in the illustrated embodiment, extends from the side wall of the compartment through to the axis of rotation of the rotary disc, thereby ensuring that the hot airstream from the clinker cooler flows across the waste following almost the same path, only at a much higher velocity. As a consequence thereof, the exhaust gases produced during incineration are expelled from the compartment and diverted into the calciner where they are utilized for calcination of cement raw meal.

The retention time of the waste in the compartment may be controlled simply by regulating the speed of rotation of the rotary disc. Significant advantages may be gained by operating at a high velocity for a short period of time followed by an idle period of prolonged duration or by operation at high velocity, separated by shorter periods in reverse mode of operation. The different modes of separation allow the retention time of the waste to be varied to ensure complete incineration of the waste material.

FIGS. 4 and 5 show an alternative embodiment in which the supporting surface 21 is stationary. In this embodiment the means for transporting the waste through the compartment preferably comprises of a scoop wheel 31 with at least two scoops 33 which rotate about an axis 35 extending perpendicularly to the supporting surface.

In the event of there being a risk of overheating and/or explosion in the compartment 9, cold raw meal from a raw meal store 17 or a dedicated emergency hopper can be fed to the compartment. The cold raw meal should preferably be supplied in a quantity which is sufficient for cooling the waste and to shield it against the impact of the hot airstream from the clinker cooler 7.

Waste, raw meal and hot air can be introduced into the compartment 9 via one and the same inlet, for example the inlet 11, as shown in FIGS. 1, 4 and 5.

FIG. 6 shows an embodiment of the apparatus for incineration of waste during the manufacture of cement, installed with the HMT.

As illustrated in FIG. 6, compartment 9 is arranged at a distance from the calciner 3 or a preheater tower by means of a material chute 40. The material chute 40 enters a downward sloping duct. The duct carries exit gas from the compartment 9 and non-combustible material from waste fuel firing in the compartment 9 down into the calciner or preheater tower.

The mechanical means are arranged in the duct, so as to ensure that the material flows downwards.

In other preferred embodiment the mechanical means are in the form of air blasters arranged in the duct. Alternately, the mechanical means could be in the form of a mechanical pusher located inside of the duct.

Although the present invention has been described in connection with the specified embodiments, it should not be construed as being in any way limited to the presented examples. It should also be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

### REFERENCES

1. Preheater
3. Calciner
5. Kiln
7. Clinker cooler
9. Compartment
11. Waste inlet
12. Raw meal inlet
17. Raw meal store
21. Supporting surface
23. Outlet
25. Axis
27. Scraper mechanism
29. Partition wall
31. Scoop wheel
33. Scoop
40. Material chute

1. A method for incineration of combustible waste during the manufacture of cement clinker where cement raw meal is preheated and calcined in a preheater with a calciner, burned into clinker in a kiln and cooled in a subsequent clinker cooler, in which method the waste is incinerated in a separate compartment subject to simultaneous supply of hot air, the exhaust gases produced during the waste incineration process being vented to the preheater for heating the cement raw meal, and the slag generated during the waste incineration process being extracted from the compartment,
the waste is introduced via a waste inlet onto a supporting surface incorporated in the compartment and in that, during incineration, the waste is transported through the compartment to the outlet of the compartment along a circular path, characterized in that the compartment is arranged at a distance from said calciner or a preheater tower via a material chute said material chute enters a downward sloping duct, said duct carries exit gas from said compartment and non-combustible material from waste fuel firing in said compartment down into the calciner or preheater tower.

2. The method according to claim 1, wherein that mechanical means are arranged in said duct, so as to ensure that said material flows downwards.

3. The method according to claim 1, comprising air blasters arranged in said duct.

4. The method according to claim 1, comprising in mechanical pusher located in said duct.

5. The method according to claim 1, comprising: controlling the temperature in the waste incineration compartment via introducing cement raw meal is introduced into the compartment via a cement raw meal inlet.

6. The A method according to claim 1, comprising:
extracting the hot airstream being fed to the compartment from the clinker cooler.

7. The method according to claim 1, characterized in that the exhaust gases produced during the waste incineration process are fed to the calciner of the preheater for calcination of the cement raw meal.

8. The method according to claim 1, comprising:
extracting the slag generated during the waste incineration process and any unburned waste from the compartment through its outlet and directed into the calciner.

9. The method according to claim 1, comprising:
supplying cold raw meal to the compartment in event of there being a risk of overheating and/or explosion.

10. The A method according to claim 9, comprising:
feeding the cold raw meal to the compartment in a quantity which is sufficient to cool the waste and to shield it against the impact of the hot airstream.

11. An apparatus for incineration of combustible waste comprising:
a raw meal store, a preheater with a calciner, a kiln, a clinker cooler, a compartment for incineration of the waste, and an air duct for supplying hot air to the compartment, wherein the compartment comprises an inlet for introducing the waste into the compartment and an outlet for extracting slag and any unburned waste, the compartment further comprising a supporting surface for supporting the waste during incineration and a transporting device configured to transport the waste from the waste inlet to the outlet of the compartment along a circular path, the compartment being arranged at a distance from said calciner or a preheater tower via a material chute, said material chute positioned to enter a downward sloping duct, said duct positioned to carry exit gas from said compartment and non-combustible material from waste fuel firing in said compartment down into the calciner or preheater tower.

12. The apparatus according to claim 11, wherein mechanical means are arranged in said duct, so as to ensure that said material flows downwards.

13. The apparatus according to claim 11, comprising: air blasters arranged in said duct to ensure that said material flows downwards.

14. The apparatus according to claim 11, comprising: mechanical pusher located in said duct to ensure that said material flows downwards.

15. The apparatus according to claim 11, wherein the compartment comprises an inlet for introducing raw meal from the preheater, calciner and/or raw meal store.

16. The apparatus of claim 11, wherein: the supporting surface comprises a rotary disc which is configured to transport the waste through the compartment.

17. The apparatus of claim 13, comprising: a scraper mechanism positioned to expel the slag generated during the waste incineration process as well as any unburned waste from the compartment through the outlet and into the calciner.

18. The apparatus of claim 11, wherein the rotary disc constitutes the bottom of the compartment.

19. The apparatus of claim 11, wherein the rotary disc is configured for rotation about an a axis which extends through its center, and which is inclined relative to the vertical, between 1degrees and 10 degrees.

20. The apparatus of claim 11, wherein: the compartment comprises a gas-tight, stationary partition wall which is mounted in the path of rotation between the outlet and inlet of the compartment, extending from the side wall of the compartment to an axis of rotation of the rotary disc.

21. The apparatus of claim 11, wherein: disc comprises a ceramic material.

22. The apparatus of claim 11, wherein the supporting surface is stationary and the transporting device comprises an element rotating about an axis which extends perpendicularly to the supporting surface.

23. The apparatus of claim 22, wherein the transporting device comprises a scoop wheel equipped with at least two scoops.
